(19) United States
(12) Patent Application Publication
(10) Pub. No.: US 2012/0221385 A1
(43) Pub. Date: Aug. 30, 2012

(54) TRANSIT MEDIA SIGNAGE ASSEMBLY HAVING DYNAMIC AND STATIC ASSETS

(76) Inventors: Matthew Stuart Fine, Montclair, NJ (US); Marc Steven Polack, Camarillo, CA (US)

(21) Appl. No.: 13/405,121

(22) Filed: Feb. 24, 2012

Related U.S. Application Data
(60) Provisional application No. 61/446,336, filed on Feb. 24, 2011.

(51) Int. Cl. H04N 5/64; G06Q 30/02

(52) U.S. Cl. 705/14.4; 348/837; 348/E05.129

(57) ABSTRACT

A self-powered and self-contained transit media signage assembly configured to fit within a predefined space in a transit vehicle and method for managing is disclosed. Said assembly comprising a portable video display screen affixed to a wall of a transit vehicle connected to a removable power source located at a base portion of the transit media signage assembly and hidden from view by passengers, and at least one input device connected to the removable power source and to the video display screen, wherein the removable power source consists of a plurality of batteries, and wherein the portable video display screen is configured to receive a plurality of dynamic video assets stored in a server and transmitted to the video display screen via a plurality of workstations. The dynamic video assets consists of up-to-date advertising and informational advisories, combined with static print advertising that also functions to conceal the power source.

CROSS-REFERENCE TO RELATED APPLICATION

This application claims the priority filing date of provisional patent application No. 61/446,336 filed on Feb. 24, 2011.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

This disclosure relates to media signage assemblies, and more particularly to a media signage assembly having dynamic and static assets for providing improved advertising content to a plurality of users.

Media signage systems are usually displayed in public venues such as outdoor advertising locations, retail outlets, stadiums, convention centers, arenas, municipalities, airports, transit stations, subways stations, individual subway cars, buses, commercial buildings, shopping malls etc. These systems help to provide advertisements and information to users by employing static and/or dynamic signage. Static signage allows printed advertisements to be displayed at points of purchase, transit and gathering locations. Advertising using dynamic signage allows video, advertisements and messages to be displayed on electronic displays typically with the goal of delivering targeted messages to specific locations at specific times. The content displayed by the dynamic signage systems can be programmed and updated on a real time-basis by a user. Most of the electronic signage normally requires sophisticated hardware and software to display the advertising content to the user.

U.S. Pat. No. 7,972,031 issued to Ray on Jul. 5, 2011 describes an addressable or static light-emitting or electronic apparatus. The apparatus comprises a substrate having a plurality of cavities; a plurality of first conductors coupled to the substrate and at least partially within the cavities; the plurality of first conductors having a first and substantially parallel orientation; a plurality of light emitting diodes or other electronic components coupled to the plurality of first conductors and having a second orientation substantially normal to the first orientation; and a plurality of substantially optically transmissive second conductors coupled to the plurality of light emitting diodes; and having a third orientation substantially normal to the second orientation and substantially perpendicular to the first orientation. The electronic apparatus may be regional or static, such as for signage, or which may be addressable, such as for the display of changing information.

U.S. Pat. No. 7,742,950 issued to Wolinsky on Jun. 22, 2010 discloses a system and method for distributing content for a broadcaster on a communications network. The system includes a database operable to maintain the content for the broadcaster, the broadcaster being a subscriber for use of at least one visual appliance. A user interface is in communication with the database and is operable (i) to provide a self-servicing scheduler for the broadcaster to form a playlist of the content and (ii) to distribute the playlist and associated scheduled content across the communications network. A server may be operable to receive the playlist and scheduled content associated therewith via the communications network. A visual appliance is in communication with the server and is operable to receive and display the scheduled content.

U.S. Pat. No. 7,685,259 issued to Strand on Mar. 23, 2010 discloses a locally-responsive kiosk signage from an on-line source. In this system, displayed content of signage at a distal location is at least partially controlled by a processor and database that directs the signage display from a distal location. A central location processing system collects information on local, area wide, national or international conditions, events or changes in status and directs local signage to display appropriate information. The central location also collects information, samples information, and evaluates general information to determine what specific information may be appropriately or desirably displayed at local signage. The display is relevant to seasonal events such as holidays, sports events, actual changes in season, school year beginnings or endings, political events and the like, or independent events or conditions such as weather changes, severe weather, sales events, consumer alerts, public alerts, and special event days.

U.S. Pat. Application No. 20090144157 issued to Saracino on Jun. 4, 2009 describes a system, apparatus, method, and media directed to digital signage. The system includes a computer component for grouping a plurality of digital signage types into at least one of a plurality of digital signage channels; a computer component for generating at least one template for at least one of the digital signage channels; a computer component for creating a new digital signage message for a portion of at least one of the selected templates wherein the templates provide a separation between a view and a model of the new digital sign; a computer component for approving the new digital signage message based on a limited representational view of the new digital signage message; a computer component for selectively providing, over a network channel, a first renderable instance of the approved new digital signage in a first rendering format to a first digital signage device configured to display the first rendering format; and a second renderable instance in a second rendering format to a second digital signage device configured to display the second rendering format.

All of the systems and methods discussed above have considerable drawbacks for displaying advertising content to the users. All the conventional signage systems discussed above employ sophisticated hardware and software. These systems require manual programming which can often be a laborious, time-consuming process. Conventional signage systems do not provide static and dynamic signage in a single assembly. These systems cannot be configured to fit within a transit vehicle. In addition, these systems utilize video screens that require power from transit stations which can make the installation process complex. Finally, these systems are not usually portable. By not depending on power source from transit stations and by being portable, video advertising can be placed virtually anywhere in a transit car, and in places where conventional video advertising could not appear due to power source limitations. A further benefit would be that the invention can be redeployed from out-of-service transit vehicles, and installed in newer ones without having to create new signage assemblies for newer transit vehicles.

Therefore, there is a need for a simple, portable and easily configurable media signage assembly that can be used to display advertising content to the user in a transit system. Such a needed assembly would easily be programmed and upgraded utilizing communication links. Such an assembly would provide dynamic and static signage in a single system. Further, the assembly would be easily configured to fit within a transit vehicle. Such an assembly would be self-powered, self-contained and easily installed by the user. The present embodiment accomplishes these objectives.

### SUMMARY

The preferred embodiment in accordance with the present invention is a system for managing a plurality of dynamic assets utilizing a media application over a communication network in accordance with the present invention. The system comprises a plurality of workstations connected to the communication network by means of a plurality of first communication links, a server connected to each of the plurality of workstations over the communication network by means of a second communication link and at least one media signage assembly connected to one of the plurality of workstations. The communication network is configured to provide communication between the plurality of workstations and the server regarding data related to the plurality of dynamic assets. The media application is configured to manage the plurality of dynamic assets utilizing the plurality of workstations, the server and the communication network. The plurality of workstations are connected by means of the plurality of first communication links to the communication network which in turn is connected to the server by means of the second communication link. Each of the plurality of workstations is configured to receive the data related to the plurality of dynamic assets from the server via the communication network and also configured to transmit the plurality of dynamic assets to the at least one media signage assembly. The at least one media signage assembly is configured to display at least one of the plurality of dynamic assets received from one of the plurality of workstations.

A method for managing a plurality of dynamic assets over a communication network is initiated by storing data related to the plurality of dynamic assets is in a server. The data related to the plurality of dynamic assets is transmitted by the server to a plurality of workstations via the communication network. The data related to the plurality of dynamic assets is then received by each of the plurality of workstations via the communication network as indicated. At least one of the plurality of dynamic assets is then forwarded to at least one media signage assembly by one of the plurality of workstations. Finally, the at least one of the plurality of dynamic assets are displayed on a video screen of the at least one media signage assembly.

### BRIEF DESCRIPTION OF THE FIGURES

FIG. 1 is a schematic diagram of a system for managing a plurality of dynamic assets utilizing a media application over a communication network in accordance with the present invention.

FIG. 2 is a detailed schematic diagram of the system shown in FIG. 1.

FIG. 3 is an operational flow chart of a method for managing a plurality of dynamic assets over a communication network in accordance with the present invention.

FIGS. 4A-4B illustrate an exemplary embodiment of a media signage assembly in accordance with the present invention.

FIGS. 5A-5B illustrate the media signage assembly displaying at least one of the plurality of dynamic assets and one of the plurality of static assets in accordance with the present invention.

FIGS. 5C-5D illustrate the media signage assembly installed in a transit vehicle.

FIG. 6 illustrates the media signage assembly installed within an existing lighting structure in a subway car in accordance with the present invention.

### REFERENCE NUMERALS

10 . . . System for managing a plurality of dynamic assets utilizing a media application over a communication network
12 . . . Communication network
14 . . . Plurality of workstations
16 . . . Plurality of first communication links
18 . . . Server
20 . . . Second communication link
22 . . . Media signage assembly
24 . . . Processor
26 . . . Display
28 . . . Memory
30 . . . Input device
32 . . . Server processor
34 . . . Server display
36 . . . Server memory
38 . . . Server input device
40 . . . Storing data related to the plurality of dynamic assets by a server
42 . . . Transmitting the data related to the plurality of dynamic assets by the server to a plurality of workstations via the communication network
44 . . . Receiving the data related to the plurality of dynamic assets by each of the plurality of workstations via the communication network
46 . . . Forwarding at least one of the plurality of dynamic assets to at least one media signage assembly by one of the plurality of workstations
48 . . . Displaying the at least one of the plurality of dynamic assets on a video screen of the at least one media signage assembly
50 . . . Video screen
52 . . . At least one of the plurality of dynamic assets
54 . . . Removable power source
56 . . . Base portion of the at least one media signage assembly
58 . . . One of the plurality of static assets
60 . . . At least one input device of the at least one media signage assembly
62 . . . Transit vehicle
64 . . . .Subway car

### DETAILED DESCRIPTION

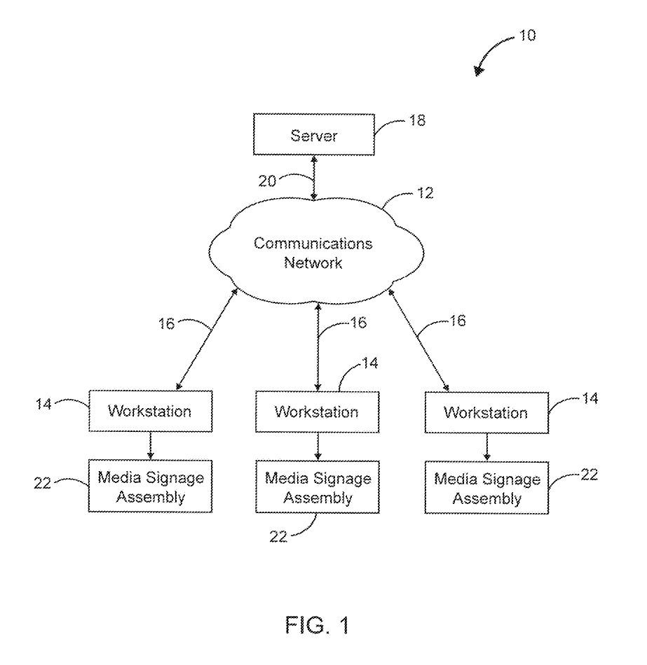

FIG. 1 is a schematic diagram of a system 10 for managing a plurality of dynamic assets utilizing a media application over a communication network 12 in accordance with the present invention. The system 10 comprises a plurality of workstations 14 connected to the communication network 12 by means of a plurality of first communication links 16, a server 18 connected to each of the plurality of workstations 14 over the communication network 12 by means of a second communication link 20 and at least one media signage assembly 22 connected to one of the plurality of workstations 14. The communication network 12 is configured to provide communication between the plurality of workstations 14 and the server 18 regarding data related to the plurality of dynamic assets. The media application (not shown) is configured to manage the plurality of dynamic assets (not shown) utilizing the plurality of workstations 14, the server 18 and the communication network 12.

The plurality of workstations 14 are connected by means of the plurality of first communication links 16 to the communication network 12 which in turn is connected to the server 18 by means of the second communication link 20. The plurality of first communication links 16 may be selected from a group consisting of: network links, dial-up links, wireless links and hard-wired links. The second communication link 20 may be selected from a group consisting of: network links, dial-up links, wireless links and hard-wired links. The plurality of workstations 14 may be local to each other or remote from each other. Each of the plurality of workstations 14 may be selected from a group consisting of: general purpose computers, personal computers, laptop computers, mainframe computers, dumb terminals, data displays, Internet browsers, personal digital assistants, two-way pagers, wireless terminals portable telephones and multi-media devices. The server 18 may be selected from a group consisting of: computers and data processing devices. The communication network 12 may be selected from a group consisting of: the Internet, Intranet, a wide-area network (WAN), a local-area network (LAN), a wireless network, a digital subscriber line (DSL) network, a frame relay network, an asynchronous transfer mode (ATM) network, and a virtual private network (VPN). Each of the plurality of workstations 14 is configured to receive the data related to the plurality of dynamic assets from the server 18 via the communication network 12 and also configured to transmit the plurality of dynamic assets to the at least one media signage assembly 22. The at least one media signage assembly 22 is configured to display at least one of the plurality of dynamic assets (not shown) received from one of the plurality of workstations 14.

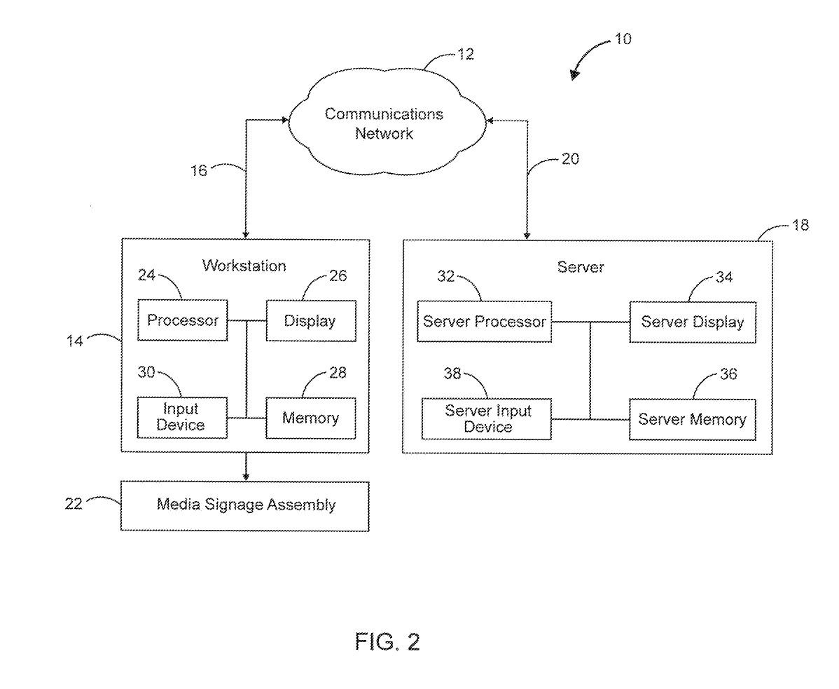

FIG. 2 is a detailed schematic diagram of the system shown in FIG. 1. Each of the plurality of workstations 14 comprises a processor 24 adaptable to manage the data related to the plurality of dynamic assets, a display 26 programmed to display the plurality of dynamic assets, a memory 28 configured to store the data related to the plurality of dynamic assets and an input device 30 configured to provide input to each of the plurality of workstations 14. The processor 24, the display 26, the memory 28 and the input device 30 may be interconnected. The processor 24 may be selected from a group consisting of: microprocessors, digital signal processors and controllers. The memory 28 includes a storage device for storing a computer program to control the processor 24. The processor 24 utilizes the computer program to display the plurality of dynamic assets managed by the media application. The processor 24 also utilizes the computer program to handle the data received through the plurality of first communication links 16 from the plurality of workstations 14. The input device 30 may be selected from a group consisting of: computer keyboards, cursor-controllers, dials, switchbanks and levers.

The server 18 is connected to each of the plurality of workstations 14 over the communication network 12 by means of the second communication link 20.

The server comprises a server processor 32 adaptable to manage the data related to the plurality of dynamic assets,a server display 34 programmed to display the plurality of dynamic assets received by the server 18, a server memory 36 configured to store the data related to the plurality of dynamic assets and a server input device 38 configured to provide input to the server 18. The server processor 32, the server display 34, the server memory 36 and the server input device 38 may be interconnected. The server processor 32 may be selected from a group consisting of: microprocessors, digital signal processors and controllers. The server memory 36 includes a storage device for storing the data related to the plurality of dynamic assets. The storage device further includes a server program for controlling the server processor 32. The server input device 38 may be selected from a group consisting of: computer keyboards, cursor-controllers, dials, switchbanks and levers. The plurality of workstations 14, the server 18 and the at least one media signage assembly 22 may be located at any suitable location.

In some embodiments, the memory 28 and the server memory 36 can be any suitable computer readable media can be used for storing the data related to the plurality of dynamic assets. For example, the computer readable media can be transitory or non-transitory. Transitory computer readable media can be selected from a group consisting of: signals on networks, signals in wires, conductors, optical fibers, circuits, or any intangible media. Non-transitory computer readable media can be selected from a group consisting of: magnetic media, optical media, semiconductor media, electrically erasable programmable read only memory (EEPROM) or any suitable tangible media.

The system 10 may include one or more servers. The server 18 and the plurality of workstations 14 can include any suitable components such as a processor, a memory, communication interfaces, display controllers, input devices etc. The plurality of dynamic assets can be managed by the media application. The media application may be implemented in the memory 28 or the server memory 36 of the system 10. The media application may be selected from a group consisting of: application program interface and graphical user interface (GUI). The server 18 may be any suitable server for providing access to the media application, such as a processor, a computer, a data processing device, or a combination of such devices. The media application can be distributed into multiple backend components and multiple frontend components or interfaces. In a more particular example, backend components, such as content management and content distribution can be performed on the server 18. Similarly, the graphical user interfaces displayed by the media application, such as an advertising network interface, can be distributed by the server 18 to each of the plurality of workstations 14. Each of the plurality of workstations 14 is associated with an advertiser. Each of the plurality of workstations 14 enables the advertiser to access the features of the media application. In some embodiments, the media application may include client-side software, hardware or both. For example, the media application may encompass one or more web-pages or web-page portions such as Hyper Text Markup Language (HTML), Dynamic Hyper Text Markup Language (DHTML), Extensible Markup Language(XML), Java Server Pages (JSP), Active Server Pages (ASP), Cold Fusion, or any other suitable approaches.

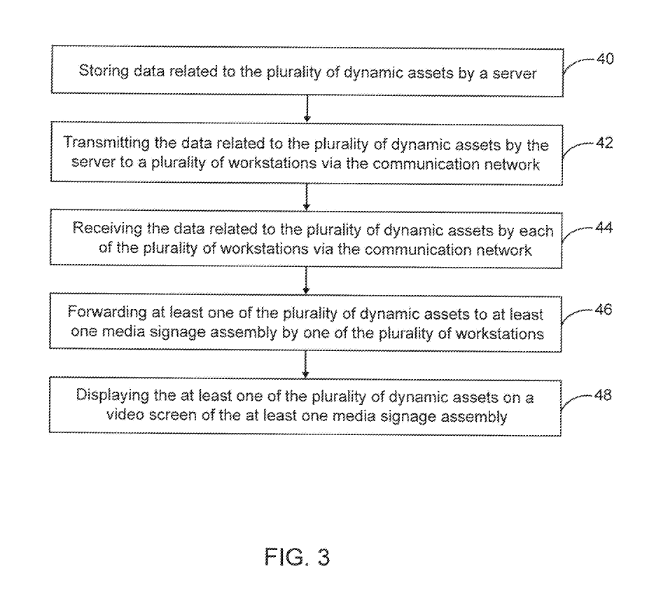

FIG. 3 is an operational flow chart of a method for managing a plurality of dynamic assets over a communication network in accordance with the present invention. Initially, data related to the plurality of dynamic assets is stored in a server 40. Next, the data related to the plurality of dynamic assets is transmitted by the server to a plurality of workstations via the communication network as shown in block 42. The data related to the plurality of dynamic assets is then received by each of the plurality of workstations via the communication network as indicated at block 44. As shown in block 46, at least one of the plurality of dynamic assets is then forwarded to at least one media signage assembly by one of the plurality of workstations. Finally, the at least one of the plurality of dynamic assets is displayed on a video screen of the at least one media signage assembly as indicated at block. 48.

While the preferred embodiment teaches a remote server housing a plurality of dynamic assets, it is also conceivable that the dynamic assets are stored locally in the media signage assembly 22 in computer hardware. The plurality of dynamic assets can then be updated or changed through at least one input device (not shown) or by remote control (not shown).

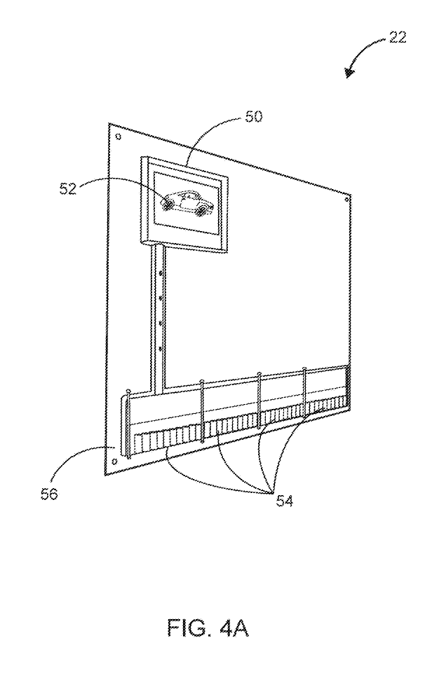

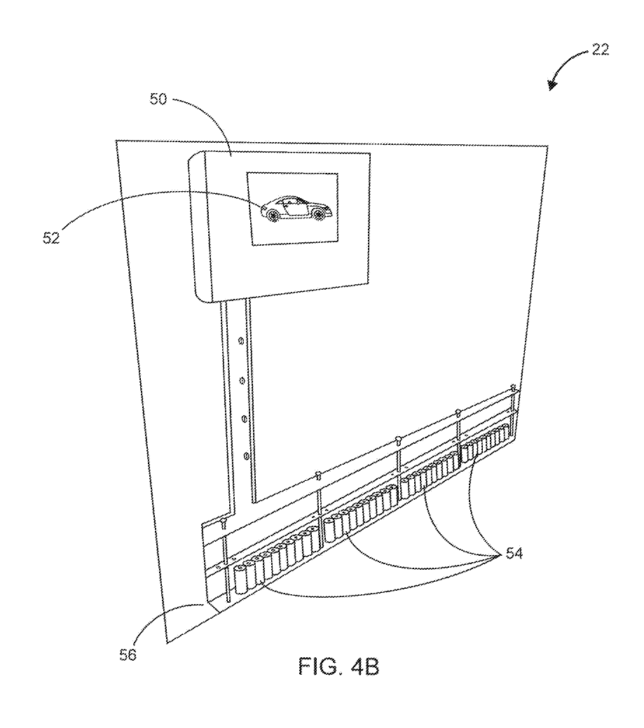

FIGS. 4A-4B illustrate an exemplary embodiment of the media signage assembly 22 in accordance with the present invention. As illustrated, the at least one media signage assembly 22 includes a removable power source 54 located at a base portion 56 of the media signage assembly 22, at least one input device (not shown) connected to the removable power source 54 and a video screen 50 programmed to display at least one of the plurality of dynamic assets 52. The video screen 50 is connected to the at least one input device of the media signage assembly and the removable power source 54. The at least one media signage assembly 22 may include a plurality of static assets. The at least one media signage assembly 22 is configured to display at least one of the plurality of dynamic assets 52 received from one of the plurality of workstations 14. The removable power source 54 may be battery packs located at the base portion 56 of the media signage assembly 22. As illustrated, the removable power source includes four battery packs with ten batteries in each pack. The media signage assembly 22 is adaptable to provide room for up to eight battery packs. The at least one of the plurality of dynamic assets 52 is displayed on the video screen 50. The at least one media signage assembly 22 provides advertising content to outdoor advertising companies, retail outlets, stadiums, convention centers, arenas, municipalities, airports, transit stations, subways stations, individual subway cars, buses, commercial buildings and shopping malls.

The media signage assembly 22 may include an audio output module. For example, the video screen 50 can include an audio component for playing audio corresponding to the video content displayed by the video screen 50. In another example, the media signage assembly 22 can include an audio player for outputting audio. A viewer of the media signage assembly 22 can attach a listening device to an audio interface for listening to the audio. The viewer can connect listening devices such as a headphone to a headset jack. In an alternate embodiment, the at least one media signage assembly 22 can be configured to allow for the insertion of a pre-existing video screen device such as a tablet computing device, a wireless email device, a personal digital assistant etc. The plurality of dynamic assets can then be loaded onto the pre-existing video screen device in response to inserting the video screen device to the media signage assembly 22.

The at least one media signage assembly 22 can be maintained by a maintenance user. In addition to updating dynamic assets, a maintenance user can remove and replace the removable power source 54. For example, a maintenance user or a field maintenance crew can manage power source changes, dynamic asset loading, static asset replacement (e.g. new printed layer with a new advertiser message), static asset removal, and/or servicing for one or more media signage assemblies. In some embodiments, the at least one of the plurality of the dynamic assets 52 played on the video screen 50 of the assembly can be modified and/or updated using the communications links. In a more particular example, an advertiser can transmit a revised video or a portion of an advertisement campaign to the media signage assembly 22 for display. In another example, the advertiser can replace the currently displayed dynamic assets 52 with informational contents such as an emergency service announcement, weather advisory, a transit delay message, etc.

In some embodiments, instead of dynamically updating the content, the maintenance user can update the dynamic assets using any suitable approach. For example, the maintenance user can connect a memory device such as a USB memory device or flash drive to the media signage assembly 22 using a suitable interface such as USB, mini-USB, an SD card, a Compact Flash card, etc. In another example, the maintenance user can remove the video screen 50 displaying the at least one of the plurality of dynamic assets 52 and install a different video screen having another set of dynamic assets. In yet another example, the maintenance user can connect the media signage assembly 22 to a wired or wireless transmission device that connects to a content server for updating the plurality of dynamic assets.

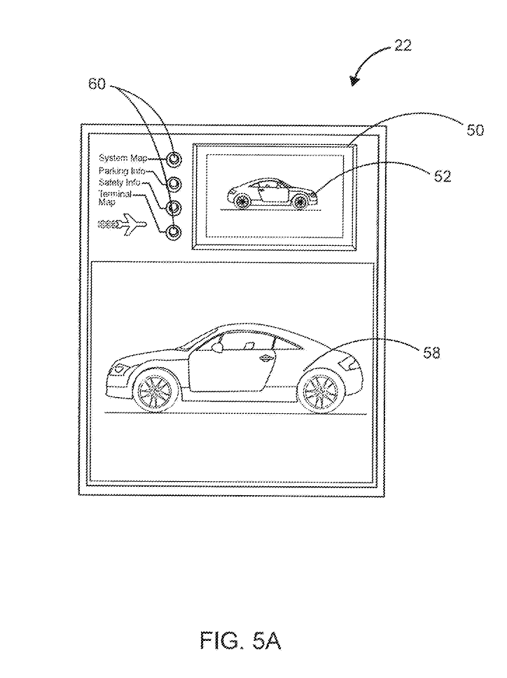

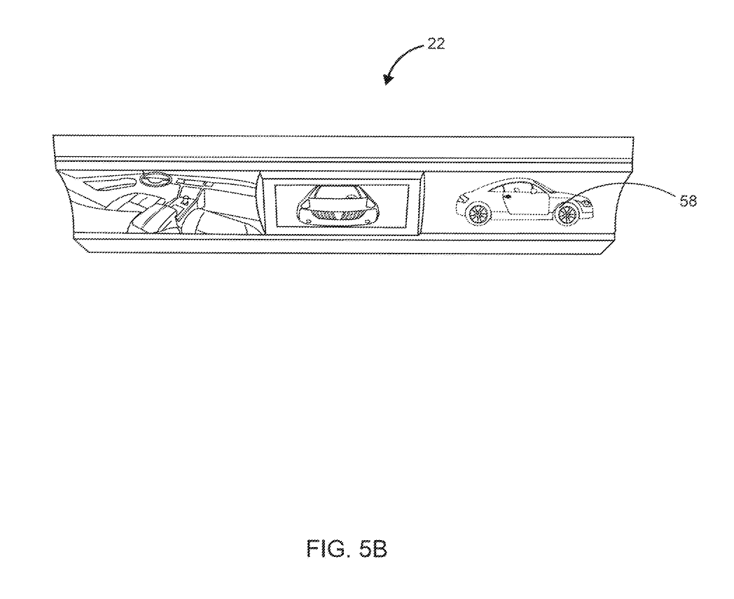

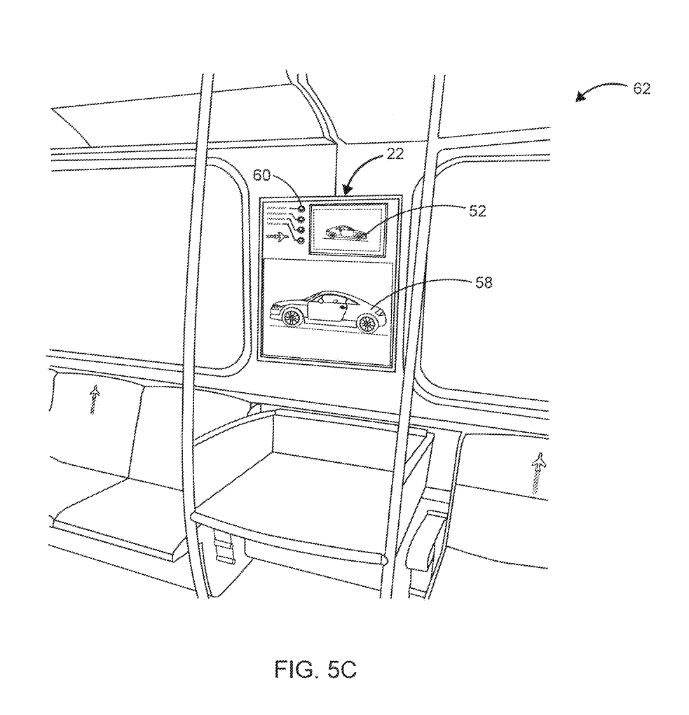

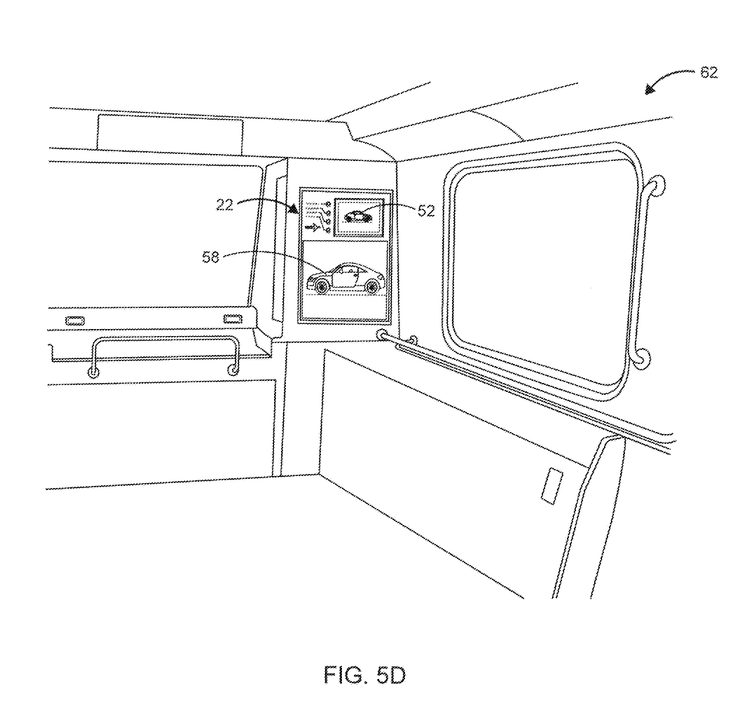

FIGS. 5A-5B illustrate the media signage assembly displaying the at least one of the plurality of dynamic assets 52 and one of the plurality of static assets 58 in accordance with the present invention. A static asset 58, such as customized vinyl or polyethylene sheet that includes printed advertising, can be placed over at least a portion of the removable power source 54, the at least one input device of the media signage assembly 60, and the video screen 50. Openings can be provided within the static asset 58 such that the video screen 50 and the at least one input device of the media signage assembly 60 remain unobstructed. In addition, the static asset 58 can be placed over the media signage assembly 22 to protect the media signage assembly 22 from damage, aging, etc. The static asset 58 can be in the form of a polyethylene sheet having print advertising or printed messages, where the polyethylene sheet adheres to the outer surface of the media signage assembly 22. The at least one input device of the media signage assembly 60 can control the at least one of the plurality of dynamic assets 52. The at least one input device of the media signage assembly 60 may be selected from a group consisting of: buttons and keypad. The advertiser can transmit instructions via communications links to configure the at least one input device of the media signage assembly 60. For example, the at least one input device of the media signage assembly 60 can be configured to playback an informational video relating to safety in the transit system.

The media signage assembly 22 can be constructed to accommodate a pre-existing industry standard signage. For example, the media signage assembly 22 can be constructed to fit a one-sheet frame, a two-sheet frame, a three-sheet frame, a subway car card, or any other suitable signage standard. In another example, the media signage assembly 22 can be configured to fit an area where advertisers are not typically allowed to provide dynamic assets. More particularly, the media signage assembly 22 can provide advertisers, transit authorities, or any other suitable entity with an opportunity to provide dynamic, updateable video content such as video advertisements, informational content, etc. along with the static assets.

FIGS. 5C-5D illustrate the media signage assembly 22 installed in a transit vehicle 62. The media signage assembly 22 can be configured to accommodate a pre-existing transit vehicle such as a train car, a subway car, a taxicab, a bus, etc. The media signage assembly 22 displaying the at least one of the plurality of dynamic assets 52 and one of the static assets 58 over at least a portion of the media signage assembly 22 is illustrated. In addition, static assets can be placed internally within the transit vehicle and externally on the outside of the transit vehicle. For example, multiple polyethylene sheets having printed advertisements that correlate to the plurality of the dynamic assets can be placed throughout the interior and exterior of the transit vehicle. In some embodiments, the media signage assembly 22 can be connected to an external power source. For example, if a transit authority provides an external power source, the media signage assembly can be configured to receive power from such a power source. The at least one of the plurality of dynamic assets 52 may be selected from a group consisting of: a video played back on a video-enabled display and an interactive video content. One of the plurality of static assets 58 may be a printed advertising.

In some embodiments, the media signage assembly 22 can be upgraded to include wireless communications links. For example, the media signage assembly 22 installed in the transit vehicle 62 to playback content local to the media signage assembly 22 such as preloaded content, content on removable media read by a processor in the media signage assembly, etc. can be upgraded such that the media signage assembly 22 is connected to a network-enabled content provided via broadcast, cable, satellite, Internet, or other means. The media signage assembly 22 can be modified to include additional communications paths selected from a group consisting of: satellite paths, fiber-optic paths cable paths, path that supports Internet communications, free space connections, short-range point-to-point communications paths such as Bluetooth, infrared, USB cables, etc. or any other suitable wired or wireless communications path or combination of such paths.

Utilizing the wireless communications links, the illustrative media signage assembly 22 can be configured to receive station-specific information. In response to the transit vehicle 62 reaching a predetermined location, the maintenance user can communicate with the media signage assembly 22 via the wireless communications links. The maintenance user can upload a transit advisory or any other suitable information message to the media signage assembly 22 in response to a known service change. The maintenance user can generate the transit advisory utilizing one of the plurality of workstations 14 and transmit the generated advisory to the media signage assembly 22 in the transit vehicle 62. Additionally or alternatively, the maintenance user can remotely startup or shutdown the media signage assembly. The media signage assembly 22 can provide informational messages relating to the next stop on a particular transit system (for example, tourist information, connection or transfer information, etc.).

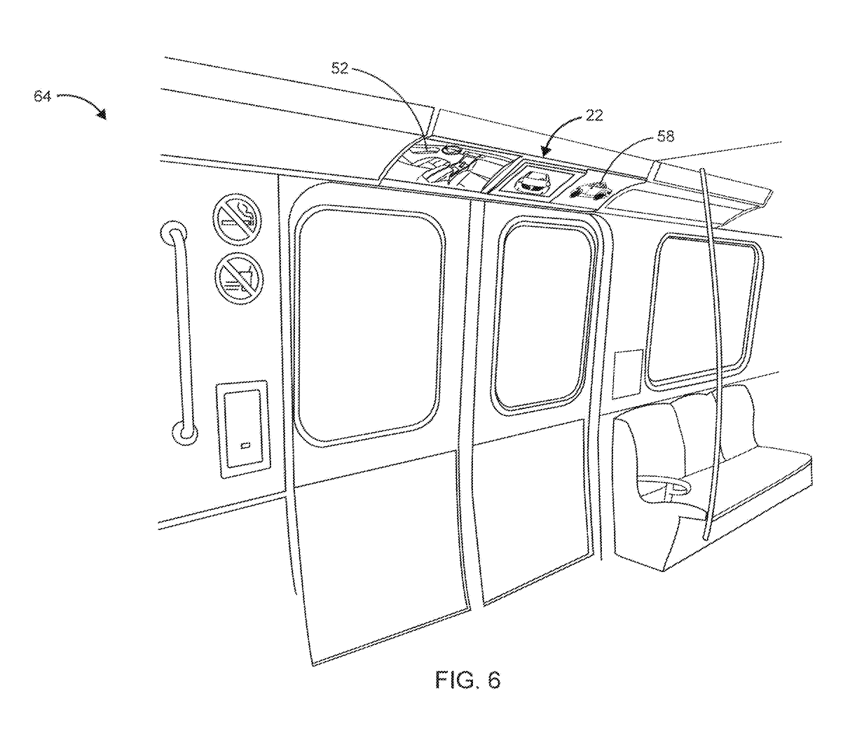

FIG. 6 illustrates the media signage assembly 22 installed within an existing lighting structure in a subway car 64 in accordance with the present invention. The media signage assembly 22 can be retrofitted into existing structures, such as an existing light fixture in a railcar, a two sheet frame in a transit station, etc. This is desirable in environments where no new signage structures can be added. As shown, the media signage assembly 22 including the plurality of dynamic assets relating to static assets is installed within an existing light fixture. In some embodiments, the media signage assembly 22 is self-powered and self contained. By providing a self-powered and self-contained media signage assembly 22, the media signage assembly 22 can be installed in locations where displaying dynamic assets is typically not available to advertisers. For example, in a transit system operated by a transit authority, the media signage assembly 22 can be installed, where the transit authority generally does not allow an advertiser to install the video screen 50 providing video content within the transit system such that it receives power from the transit system. Similarly, in a transit station operated and maintained by a transit authority, the media signage assembly 22 can be installed, where the transit authority also does not allow an advertiser to install a video screen that receives power from the transit station and requires special installation causing damage to the transit station.

In addition, the media signage assembly 22 can be configured to fit within a predefined space in the transit vehicle 62. It may be noted that any suitable mechanism can be used to install the media signage assembly 22 without modifying or damaging the transit vehicle 62. The media signage assembly 22 can include compression or pressure fittings that affix the media signage assembly 22 between pre-existing brackets in the transit vehicle 62. The pressure fittings can hold the media signage assembly 22 in a particular location of a typical subway car 64. The media signage assembly 22 can also be held in place using a magnetic mechanism a hydraulic mechanism, or any other suitable mechanism that holds the media signage assembly 22 in place without damaging the transit vehicle 62. In addition to avoiding damage to the transit vehicle 62, the use of a pressure or magnetic mechanism allows the media signage assembly 22 to be removed for maintenance, replacement, and/or updating. The media signage assembly 22 can be configured to be portable and upgradable. For example, the media signage assembly 22 that is configured to fit within a predefined space in a transit vehicle 62, such as a railcar, can be removed and reinstalled into another transit vehicle.

In some embodiments, the plurality of dynamic assets can be modified and/or updated using any suitable approach. For example, a train conductor can update the dynamic assets on the media signage assembly 22 in response to a train delay. The train conductor can request that a countdown clock be displayed for a particular train delay on the video screen 50 of the media signage assembly 22. In another example, the train conductor can request that a news program is streamed to the media signage assembly 22 for display. In another suitable embodiment, the plurality of dynamic assets can be updated at multiple locations.

Although the media application is described herein as being implemented on one of the plurality of workstations and/or server, this is only illustrative. The media application may be implemented on any suitable platform such as a personal computer, a mainframe computer, a dumb terminal, a data display, a two-way pager, a wireless terminal, a portable telephone, a portable computer, a palmtop computer, a handheld personal computer (H/PC), an automobile PC, a laptop computer, a cellular phone, a personal digital assistant (PDA), a combined cellular phone, PDA etc to provide such features. It will also be understood that the detailed description herein may be presented in terms of program procedures executed on a workstations or network of plurality of workstations and a server. These procedural descriptions and representations are the means used by those skilled in the art to most effectively convey the substance of their work to others skilled in the art.

A method is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. However, all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

Accordingly, a media signage assembly having the plurality of dynamic assets and the plurality of static assets and methods for using the same are provided. Although the present invention has been described and illustrated in the foregoing exemplary embodiments, it is understood that the present disclosure has been made only by way of example, and that numerous changes in the details of implementation of the invention may be made without departing from the spirit and scope of the invention. For example, the plurality of workstations 14, the server 18 and the at least one media signage assembly 22 may be located within an organization. Alternatively, the plurality of workstations 14, the server 18 and the at least one media signage assembly 22 may be distributed between multiple organizations. Features of the disclosed embodiments can be combined and rearranged in various ways.

What is claimed is:

1. A self-powered and self-contained transit media signage assembly configured to fit within a predefined space in a transit vehicle, comprised of a portable video display screen affixed to a wall of a transit vehicle connected to a removable power source located at a base portion of the transit media signage assembly and hidden from view by passengers, and at least one input device connected to the removable power source and to the video display screen, wherein the removable power source consists of a plurality of batteries, and wherein the portable video display screen is configured to receive a plurality of dynamic video assets stored in a server and transmitted to the video display screen via a plurality of workstations.

2. The transit media signage assembly of claim 1 further comprising an audio output module.

3. The transit media signage assembly of claim 1 further comprising an audio interface for a listening device.

4. The transmit media signage assembly of claim 1 further comprising an interface for a pre-existing video screen device for downloading dynamic video assets from the transit media signage assembly to the pre-existing video screen device.

5. The transmit media signage assembly of claim 4, wherein the pre-existing video screen device is a tablet computing device, a wireless email device, or a personal digital assistant.

6. The transit media signage assembly of claim 1 further comprising a USB port for uploading updated dynamic video assets via a flash drive.

7. The transit media signage assembly of claim 1 further comprising at least one input device to allow a transit user to control at least one of the plurality of dynamic video assets on the video display screen.

8. The transit media signage assembly of claim 7 further comprising at least one of a plurality of static assets in the form of printed advertisement placed over at least a portion of the removable power source, said static asset comprising at least one opening for the video display screen and at least one opening for the at least one input device.

9. A self-powered and self-contained transit media signage assembly configured to fit within a predefined space in a transit vehicle, comprised of a portable video display screen affixed to a wall of a transit vehicle connected to a removable power source located at a base portion of the transit media signage assembly and hidden from view by passengers, and at least one input device connected to the removable power source and to the video display screen, wherein the removable power source consists of a plurality of batteries, and wherein the portable video display screen comprises computer hardware that stores a plurality of dynamic video assets which can be changed by remote control or through the input device.

10. A method for managing self-powered and self-contained transit media signage assembly of claim 1 using at least one portable video display screen capable of displaying a plurality of dynamic video assets and installed in transit vehicles independent of a fixed power source, said dynamic assets being stored in a server, transmitted by the server to a plurality of workstations via a communications network, and forwarded to at least one transit media signage assembly, wherein:
the dynamic video assets consists of up-to-date advertisements and advisory information;
said plurality of dynamic video assets are transmitted wirelessly by an advertiser to the video display screen, uploaded by a maintenance worker via a USB port, or transmitted by a maintenance worker by replacing the portable video screens with other portable video screens containing the up-to-date advertisements and advisory information;
said transit media signage further comprising at least one of a plurality of static assets in the form of printed advertisement placed over at least a portion of a removable power source for the media signage assembly and containing at least one opening for the video display screen and at least one opening for an input device.
